(19) United States
(12) Patent Application Publication
(10) Pub. No.: US 2005/0219043 A1
(43) Pub. Date: Oct. 6, 2005

(54) Locking system for a vehicle and method for operating thereof

(76) Inventors: Rainer Pollmann, Isen (DE); Peter Brandl, Altdorf (DE); Manfred Rohlfing, Velbert (DE); Martin Witte, Ahaus (DE)

Correspondence Address: PENDORF & CUTLIFF, 5111 MEMORIAL HIGHWAY, TAMPA, FL, 33634-7356, US

(21) Appl. No.: 11/099,335

(22) Filed: Apr. 5, 2005

(30) Foreign Application Priority Data
Apr. 5, 2004 (DE) 10 2004 017 243.9

(51) Int. Cl. B60R 25/10

(52) U.S. Cl. 340/426.28; 340/5.72; 340/562; 340/522; 340/501

(57) ABSTRACT

Locking system for a vehicle, in which a locking/unlocking function can be initiated by the activation of at least one capacitate sensor located on an external handle of the vehicle entry, wherein the sensor includes at least a second control surface not accessible to the user or accessible only with difficulty, via which the impact of environmental influences on the sensor by can be distinguished from the activation of the sensor by the user through detection of control surface selective signal changes at the sensor. Method for operating a locking system for a vehicle, in which the vehicle is locked upon detection of an intention to lock or unlock by an activation of a first control surface by the hand of the user, and the authority to do so is confirmed using a data carrier, and that the vehicle is not locked or unlocked, when the control unit recognizes an environmental influenced activation of the sensor by the activation of the first as well as a second sensor, the second sensor not accessible to the hand of the user or accessible only with difficulty.

### BACKGROUND OF THE INVENTION

1. Field of the Invention

The invention concerns a locking system for a vehicle, wherein at least one vehicle entry has an external handle with at least one capacitance sensor, which, in conjunction with a control unit and an on-board transmitter/receiver unit in operative association with a two-way data carrier, upon activation of a first electrode or contact switch of the sensor located on the external handle, initiates a locking or unlocking function of the vehicle by means of a locking device.

2. Related Art of the Invention

The invention further concerns a method for operating a locking system for a vehicle, in which a locking/unlocking of one or more vehicle entries is initiated by activation of a first electrode of a capacitance sensor provided at an external handle, in operative association with a control unit and a two-way data carrier communicating with an on-board transmitter/receiver unit.

Modern vehicles, in particular motor vehicles, are increasingly equipped with keyless entry systems for improving the user friendliness or ease of operation. This type of locking system is disclosed for example in DE19617038C2 (U.S. Pat. No. 6,075,294) and DE10204025A1. With this door locking system, referred to as “passive entry”, the step of pressing the radio transmitter function of a conventional radio signal transmitting vehicle key for locking or unlocking of the vehicle via a locking device, in particular a central locking device, is dispensed with. Instead, upon approaching or contacting the external handle of the vehicle door a sensor is activated, which initiates the operation of the central locking system, so long as the user is an authorized user. The authorized user carries a data carrier with him, which upon approaching the vehicle engages in a bi-directional communication with a vehicle on-board transmitter/receiver unit, wherein his access authorization is checked by exchange of numeric codes. As sensors, capacitance sensors are generally employed, which are at least partially integrated in the door handle. These sensors are in the form of capacitors, which sense or become activated by the proximity of or contact by the user. As the hand of the user approaches, the capacitance between the electrodes of the capacitor changes, in that the user establishes a capacitance-effective contact with an electrode, since the human hand acts as a dielectric between the electrodes. If the capacitance exceeds a predetermined value, the sensor responds. Above this threshold value, or if the rate of change in capacitance detected by a control unit exceeds a certain value, then the unlocking can be initiated, subject to a previous or simultaneous positive identification of the user. For locking or, as the case may be, relocking of the vehicle, this or an additional separate capacitance sensor can be employed. The user activates the sensor by contact or by brushing against a control surface of the sensor, wherein again the authorization for this action is checked via the data carrier.

In the conventional keyless locking systems it has been found to be a problem that the operational reliability thereof can be compromised by environmental influences. In particular, an unintended locking of the vehicle can be triggered when the user, having a valid data carrier, is located in the immediate vicinity of the door handle and at this time the control surface of the lock sensor of this door external handle is impacted with water or snow. Since the capacitance sensor cannot distinguish whether it has been acted upon by a human hand or by environmental influences, the capacitance of the sensor can be caused to exceed the threshold value, which causes an erroneous functioning due to environmental influences. Thereby it is possible that persons in the vehicle become locked in the car unintentionally and without noticed.

From DE19620059A1 the locking system with a so-called dynamic capacitance proximity sensor or proximity switch is known. This sensor only switches on when the capacitance change between a door handle associated interrogating electrode and a reference electrode (mass potential) changes at a rate greater than a threshold rate. Thereby, error functions due to environmental influences are to be prevented.

It has been found to be a disadvantage with such a system that the change in capacitance, or rate in change of capacitance (capacity gradient), can vary greatly in response to the human hand or upon contact with rain or snow. Thus, on the one hand, if user slowly approaches or departs, or as the case may be, slowly contacts the sensor, this will have the consequence that the door is not unlocked or, as the case may be, locked. On the other hand, precipitation could also cause rapid capacitance changes. A reliable guarantee against malfunction is thus not readily achieved. Besides this, a relatively complex electronic circuitry is needed in order to detect and evaluate the rates of change of the capacitance.

### SUMMARY OF THE INVENTION

It is thus the task of the present invention to improve known keyless locking systems for vehicles in such a way that, with malfunctions can be avoided without expense and complexity, and that operational reliability can be improved.

In the context of the pre-characterizing portion of Patent Claim 1, the task is inventively solved in that the sensor includes at least a second control surface provided to be accessible to environmental influences and not accessible to the user, or accessible only with difficulty, with which second sensor an environmental influence on the sensor can be distinguished from the activation of the sensor by the user, namely, by detection of control-surface specific signal changes at the sensor.

The capacitance sensor for locking or unlocking is not comprised of only one, but rather of at least two, spatially separated control surfaces. These control surfaces act as a two-part sensor electrode of the capacitance sensor, wherein the capacitance of the capacitor forming the sensor changes upon approaching or contact. The control surfaces are connected with the control unit via vehicle logic. Capacitance changes at the electrodes are selectively detectable by the control unit and evaluated by means of the vehicle logic, which may be for example an electronic circuit with integrated logic. Therewith, with the aid of the second control surface located not to be accessible to the user, the control unit can distinguish in simple manner between the activation of the locking device of the vehicle by the authorized user and a false signal due to the impact on the capacitance sensor by environmental influences.

The term “locking function” is intended herein to mean both locking as well as unlocking of individual vehicle entries via individual vehicle locks as well as all vehicle locks via a central control. The term “vehicle entries” is intended to include not only vehicle doors, but rather also other areas of access, for example trunk lids, hoods or convertible tops. The term “environmental influence” is to be understood as referring not only to natural precipitation in the form of rain, snow or ice, but rather also artificially introduced external influences, for example, those of a car wash.

The second control surface is not accessible to the user, or is activated only with difficulty, so that in the case of a normal operation of the locking device this control surface does not detect the user but rather only environmental influences. The sensor thus does not activate when both control surfaces are impacted by environmental influences, for example by a capacitance-effective change due to rain, and simultaneously the authorized user, for example the data carrier of the user, is located in the vicinity of the sensor. In particular, when an environmental influence is recognized as a result of impacting of both control surfaces (with comparable capacitance changes), since the second control surface cannot be activated by the user, and as a rule environmental influences act on both control surfaces, as long as the user is not covering over the first control surface. Thereby, the operational security or reliability of the locking system is increased. Undesired actions of the locking system are avoided.

The sensor with the two control surfaces is particularly useful as a lock sensor for locking one or more vehicle doors since it reliably prevents an unintended locking-in of persons located in the vehicle due to a malfunction of the locking system, due to environmental influences acting upon the capacitance sensor.

The locking system is particularly compact and economical in construction as well as simple and reliable to operate, when the first control surface is provided at an easily accessible location on the first handle front-side of the door external handle (such as is the case, for example, conventional capacitate sensors with a control surface), and the second control surface is located at a location on the door handle not accessible to the hand of the user. This is particularly easy to realize by providing a separate lock sensor. In order to lock the vehicle, the user then simply brushes against the handle front side. Since the user cannot at this time contact the second control surface, an unintended blocking of a desired locking is precluded. The locking system can be particularly preferably employed very effectively in association with an identification provider, an ID-provider (for example a transponder), with which a data interrogation can be carried out for identification of the user. It is conceivable that, in the case that a clearly recognized impacting of both control surfaces due to environmental influences, the control unit relays to the transmitter/receiver unit a corresponding signal, whereupon the identification procedure is terminated. Thereby the operating reliability of the system can be further improved.

The known methods for operating of a locking system for a vehicle suffer from the above described disadvantages.

It is thus a further task of the present invention to so improve the known methods for operating a locking device for a vehicle so that an increased operational reliability is ensured.

The task is inventively solved in accordance with the pre-characterizing portion of Claim 9 thereby, that the control unit monitors, via a vehicle logic, the impacting of the first control surface of the sensor and a further control surface located to be impacted by environmental influences but not, or only with difficulty, to be accessible to the hand of the user, and that the vehicle can be locked or unlocked when a lock or unlocking command is recognized by the activation of the first control surface by the hand of the user and the authorization is confirmed by means of the data carrier, and that the vehicle is not locked or unlocked when the control unit recognizes an environmental-caused activation of the sensor on the basis of simultaneous impacting of both control surfaces.

Since the impact of environmental influences on the sensor are recognized using the second control surface, undesired actions of the locking system are reliably avoided. In particular the vehicle is locked or, as the case may be, secured, only when the (easily) accessible surface of the sensor is contacted and when at the same time a valid data carrier, for example an ID-provider, is located in the immediate vicinity. If, in contrast, both surfaces of the sensor are acted upon, for example with water, then the vehicle logic recognizes that this is not due to a human hand, and no action (locking) is carried out. Of course, the vehicle is also locked when significantly differing capacitance occur at the two control surfaces on the basis of an activation of the first control surface by the user and an impacting of the second control surface by environmental influences. Thereby it is ensured, that also in the case of the impacting of the sensor by environmental influences, for example by rain, the functionality of the locking system remains intact.

### BRIEF DESCRIPTION OF THE DRAWING

Further details of the invention can be seen from the following detailed description and the associated drawings, in which a preferred embodiment of the invention is represented by way of example.

FIG. 1 shows a block schematic diagram of a locking system of a vehicle.

### DETAILED DESCRIPTION OF THE INVENTION

A locking system for a vehicle is comprised essentially of a capacitance sensor 1 and a locking device 9, which is controllable via a control unit 5.

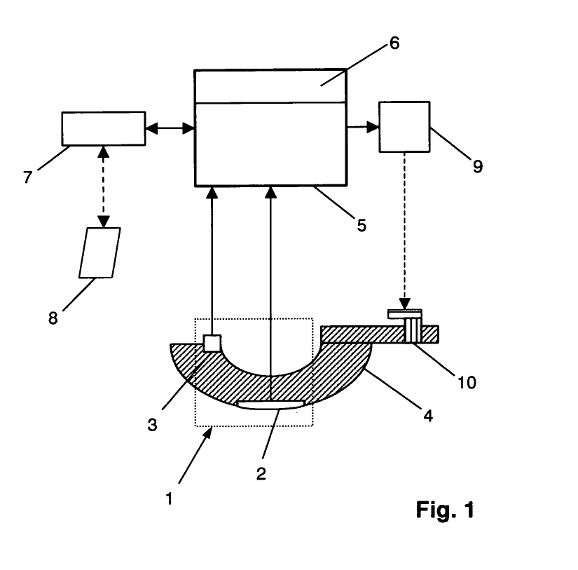

The sensor 1 is designed to have two control surfaces 2, 3 as sensor electrodes. With a not-shown reference electrode, for example a mass potentiometer, the sensor 1 together with the control surfaces 2 or, as the case may be, 3, forms a capacitor. The first control surface 2 is provided on the front side of a door external handle 4 of a not shown vehicle door. The second control surface 3 is located at an inaccessible location of the door handle 4, which is indicated in FIG. 1. The two control surfaces 2, 3 are connected with the control unit 5, which is preferably located at a central location on the vehicle. The control unit 5 is, for its part, connected with the locking device 9 and with a transmitter/receiver unit 7. The transmitter/receiver unit 7 is located in the area of the vehicle door, preferably in the door handle 4. On the door external handle 4 a vehicle door lock 10 is provided for locking/unlocking the vehicle door, which is actuated via the locking device 9, preferably a central locking system. Further there is a data carrier 8, which is carried by the user. The data carrier 8 is preferably an ID-provider, for example in credit card form, in which known transponder technology is embodied. The ID-provider 8 and the transmitter/receiver unit 7 are designed for bi-directional communications. The control unit 5 is, besides this, associated with a vehicle logic, with which the signal emissions from the sensor 1 or as the case may be the control surfaces 2, 3 can be evaluated. The two control surfaces 2, 3 of the sensor 1 form an operative association with the control unit 5 and the ID-provider 8 a security system for the locking device.

The method for operation of the locking system for the vehicle essentially requires that an impact on a capacitance sensor 1 with its two control surfaces 2 and 3 can be evaluated selectively for the different control surfaces.

The manner in which the method functions will be described on the basis of an example of a safety function for prevention of an unintended locking of the vehicle using the above described device. For this, a scenario is assumed in which a user, after exiting the vehicle, is located in the immediate vicinity of the door outer handle 4 of a vehicle door, while further passengers (still) remain in the vehicle. At the same time the vehicle may be exposed to environmental influences in the form of rain. Thereby the door outer handle 4, in particular the two control surfaces 2 and 3, would be impacted with water. The user carries the ID-provider 8 with him. The authorization inquiry for locking of the vehicle is directed to the ID-provider (transponder) 8 wirelessly via the transmitter/receiver unit 7, in particular in that the transponder 8 moves in an induction field of the transmitter/receiver 7. Thereupon the transponder 8 transmits a signal, and a bi-directional dialogue is initiated, in which the control unit 5 verifies the authorization of the user for an action (locking) on the basis of an encoding of exchanged signals. Upon positive verification, that is, in the case of a confirmed authorization, then in accordance with the state of the art, on the basis of the impact of the rain on the control surface of the capacitance sensor and the therewith associated capacitance change, which is interpreted as a command to lock, the vehicle would be undesirably locked, and the persons located in the vehicle would find themselves locked-in. In accordance with the invention, it is now prevented since the control unit 5 selectively detects the impact on both control surfaces 2, 3 and the thereby caused capacitance change. The vehicle logic 6 registers in particular a sensor signal of the second control surface 3 not accessible to the user, and recognizes that the impact is not from a human hand. Therewith, no undesired action (locking) is carried out. Of course, the vehicle logic also recognizes, on the basis of a differential sensor signal (capacity change) at the control surfaces, even when the second control surface 3 is impacted by rain, simultaneously the user, by brushing the first control surface 2, indicates a desire to lock, where upon the control unit 5 carries out in accordance with this wish the locking of the vehicle via the locking device 9.

### REFERENCE NUMBER LIST

1. Capacitance sensor

2. First control surface

3. Second control surface

4. Door exterior handle (handle)

5. Control unit

6. Vehicle logic

7. Transmitter/receiver unit

8. Data carrier

9. Locking device

10. Vehicle door lock

1. A locking system for a vehicle, wherein at least one vehicle entry includes an external handle with at least one capacitance sensor, which, with the aid of a control unit and a vehicle located transmitter/receiver unit, in operative association with a user-carried data carrier, upon activation of a first control surface of the sensor located on the external handle, initiates a locking/unlocking function of the vehicle via a locking device, wherein the sensor (1) includes at least one second control surface (3) which is accessible to environmental influences and which is not accessible or accessible only with difficulty by the user, and via which the impact of environmental influences on the sensor (1) can be distinguished from the activation of the sensor (1) by the user through detection of control surface selective signal changes at the sensor (1).

2. The locking system according to claim 1, wherein at least one sensor is provided as separate locking sensor for the locking of one or more vehicle entries.

3. The locking system according to claim 1, wherein the control surfaces (2, 3) are electrodes of the sensor (1).

4. The locking system according to claim 1, wherein the control surfaces (2, 3) of the sensor (1) are wired to the control unit (5) via vehicle logic (6).

5. The locking system according to claim 1, wherein the sensor (1) is provided on an external handle (4) of a vehicle door.

6. The locking system according to claim 1, wherein the first control surface (2) of the sensor (1) is located on a front side of the door external handle (4), and that the second control surface (3) is provided at a location on the door handle (4) not accessible to the hand of the user.

7. The locking system according to claim 1, wherein the data carrier (8) is an identification provider.

8. The locking system according to claim 7, wherein the data carrier (8) is a transponder.

9. A method for operating a locking system for a vehicle, wherein the locking or unlocking of one or more vehicle entrances is initiated by the activation of a first control surface of a capacitance sensor provided on an external handle, in operative association with a control unit and a transmitter/receiver unit onboard the vehicle communicating with a user-carried data carrier, wherein the control unit (5) monitors via vehicle logic (6) an impact on the first control surface (2) of the sensor (1) and on at least one further control surface (3) located to be influenced by environmental influences but not accessible or accessible only with difficulty by the hand of a user, and wherein the vehicle is locked or unlocked when a lock/unlock command is recognized by an activation of the first control surface (2) by the hand of the user and an authorization is confirmed by means of the data carrier (8), and wherein the vehicle is not caused to lock or unlock when the control unit (5) recognizes an environmental caused activation of the sensor (1) on the basis of the impact on both control surfaces (2, 3).
